(19) United States
(12) Patent Application Publication
(10) Pub. No.: US 2026/0252842 A1
(43) Pub. Date: Aug. 27, 2026

(54) INTELLIGENT SYSTEM FOR GENERATING DYNAMIC IMPLEMENTATION PROTOCOLS

(71) Applicant: BANK OF AMERICA CORPORATION, Charlotte, NC (US)

(72) Inventors: Shiju Kurian, Chennai (IN); Karthigeyan S, Chennai (IN); Chayan Bansal, Guwahati (IN)

(73) Assignee: BANK OF AMERICA CORPORATION, Charlotte, NC (US)

(21) Appl. No.: 19/065,048

(22) Filed: Feb. 27, 2025

(51) Int. Cl. G06N 3/042

(52) U.S. Cl. CPC G06N 3/042

(57) ABSTRACT

Systems, computer program products, and methods are described herein for generating implementation protocols. An example system receives, using an input processing subsystem, a plurality of requirements from a user. The input processing subsystem structures the received requirements as a graph comprising a plurality of nodes and a plurality of edges, wherein the nodes represent components of the requirements and the edges represent relationships between the components. A Graph Convolutional Neural Network (GCNN) processes the graph by iteratively aggregating information from the nodes and edges to capture local and global patterns. The GCNN extracts features from the nodes and edges and identifies actionable nodes and edges based on the extracted features. An implementation protocol for each requirement is then generated using the identified actionable nodes and edges.

### TECHNOLOGICAL FIELD

Embodiments of the disclosure relate to systems and methods for generating dynamic implementation protocols. More specifically, the disclosure pertains to intelligent systems that automate the creation of consumable application programming interfaces (APIs) for implementation protocol generation by leveraging advanced machine learning techniques such as Graph Convolutional Neural Networks (GCNNs) and transformers.

### BACKGROUND

Existing systems face challenges including reliance on structured input formats tailored for specific engines, dependency on specialized tools for format conversion, limited integration capabilities requiring frequent system rewrites, and inefficient mechanisms for updating configurations. These issues result in increased operational costs, slower turnaround times, and reduced scalability, highlighting the need for a more flexible and automated solution.

Applicant has identified a number of deficiencies and problems associated with current systems for generating and managing implementation protocols. Many of these identified problems have been solved by developing solutions that are included in embodiments of the present disclosure, many examples of which are described in detail herein.

### BRIEF SUMMARY

Systems, methods, and computer program products are provided for generating and managing implementation protocols.

In one aspect, a system for generating implementation protocols is presented. The system comprising: an input processing subsystem, wherein the input processing subsystem is configured to: receive a plurality of requirements from a user; and structure the plurality of requirements as a graph comprising a plurality of nodes and a plurality of edges, wherein the plurality of nodes represents components of the plurality of requirements and the plurality of edges represents relationships between the components; and a machine learning subsystem configured operatively coupled to the input processing subsystem, wherein the machine learning subsystem is configured to: process the graph using a Graph Convolutional Neural Network (GCNN) to iteratively aggregate information from the plurality of nodes and corresponding plurality of edges, capturing local and global patterns within the graph; extract, using the GCNN, a plurality of features from the plurality of nodes and the plurality of edges based on processing the graph; identify, using the GCNN, a plurality of actionable nodes and a plurality of actionable edges from the plurality of features; and generate, using the GCNN, an implementation protocol for each requirement based on the plurality of actionable nodes and the plurality of actionable edges.

In some embodiments, the generative AI subsystem is configured to analyze each implementation protocol to identify functional elements and corresponding execution logic; generate an execution block for each identified functional element within each implementation protocol, wherein each execution block comprises implementation logic, conditions, and relationships derived from the plurality of actionable nodes and the plurality of actionable edges; and format each execution block as a modular unit configured for direct integration into a logic framework.

In some embodiments, the aggregation and presentation subsystem is further configured to: aggregate the execution blocks into a unified collection of logic operation modules; and transmit the aggregated execution blocks to the user via an application programming interface (API).

In some embodiments, the execution blocks are platform agnostic.

In some embodiments, the plurality of requirements is in an unstructured format, and wherein the input processing subsystem is configured to: pre-process the unstructured data using at least one of natural language processing (NLP) techniques, data parsing algorithms, or format-specific extractors to extract components and relationships between the components for graph construction.

In some embodiments, extracting the plurality of features and the plurality of edges further comprises using random walk algorithms, semi-supervised learning algorithms, and/or decision tree algorithms.

In some embodiments, identifying the plurality of actionable nodes and the plurality of actionable edges further comprises using a rectified linear unit (ReLU).

In another aspect, a method for generating implementation protocols is presented. The method comprising: receiving, using an input processing subsystem, a plurality of requirements from a user; structuring, using the input processing subsystem, the plurality of requirements as a graph comprising a plurality of nodes and a plurality of edges, wherein the plurality of nodes represents components of the plurality of requirements and the plurality of edges represents relationships between the components; processing the graph using a Graph Convolutional Neural Network (GCNN) to iteratively aggregate information from the plurality of nodes and corresponding plurality of edges, capturing local and global patterns within the graph; extracting, using the GCNN, a plurality of features from the plurality of nodes and the plurality of edges based on processing the graph; identifying, using the GCNN, a plurality of actionable nodes and a plurality of actionable edges from the plurality of features; and generating, using the GCNN, an implementation protocol for each requirement based on the plurality of actionable nodes and the plurality of actionable edges.

In yet another aspect, a computer program product for generating implementation protocols is presented. The computer program product comprising a non-transitory computer-readable medium comprising code configured to cause an apparatus to: receive, using an input processing subsystem, a plurality of requirements from a user; structure, using the input processing subsystem, the plurality of requirements as a graph comprising a plurality of nodes and a plurality of edges, wherein the plurality of nodes represents components of the plurality of requirements and the plurality of edges represents relationships between the components; processing the graph using a Graph Convolutional Neural Network (GCNN) to iteratively aggregate information from the plurality of nodes and corresponding plurality of edges, capturing local and global patterns within the graph; extracting, using the GCNN, a plurality of features from the plurality of nodes and the plurality of edges based on processing the graph; identifying, using the GCNN, a plurality of actionable nodes and a plurality of actionable edges from the plurality of features; and generating, using the GCNN, an implementation protocol for each requirement based on the plurality of actionable nodes and the plurality of actionable edges.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for generating dynamic implementation protocol, in accordance with an embodiment of the disclosure;

FIG. 2 illustrates an exemplary data processing architecture, in accordance with an embodiment of the disclosure;

FIG. 3 illustrates a process flow for generating dynamic implementation protocol, in accordance with an embodiment of the disclosure; and

FIG. 4 illustrates a process flow for generating execution blocks, in accordance with an embodiment of the disclosure.

### DETAILED DESCRIPTION

### Overview

Embodiments of the disclosure provide an intelligent system for automating the creation and management of dynamic implementation protocols, addressing key inefficiencies in current systems. Conventional approaches rely heavily on structured input formats, such as tailored spreadsheets, that must be specifically designed for compatibility with rule engines. Such manual dependency increases complexity, turnaround time, and costs. Additionally, current solutions often require specialized tools and expertise to convert these input files into formats compatible with processing engines. Such a reliance on niche technical skills further limits scalability and adaptability.

Integration challenges exacerbate these issues, as existing systems lack the flexibility to seamlessly adapt to changing business requirements. This inflexibility necessitates frequent system updates or rewrites, creating operational bottlenecks and reducing the efficiency of logic configuration workflows. Furthermore, the process for updating configurations is slow and manual, with no automated mechanisms for dynamically selecting or deselecting configurations based on changing needs, leading to inefficiencies and higher maintenance costs.

Embodiments of the disclosure overcomes these challenges by introducing an intelligent, end-to-end system for generating implementation protocols directly from unstructured data sources such as text documents and spreadsheets. The system employs a combination of advanced machine learning techniques, including Graph Convolutional Neural Networks (GCNNs), to convert unstructured inputs (requirements) into graph representations, extract features using sampling methods like Random Walk and Semi-Supervised Learning for efficient data processing, and use transformer-based models for generating accurate implementation protocols for each input in the form of consumable APIs.

In an example embodiment, the system may receive a plurality of requirements in an unstructured format, such as free-form text, spreadsheets, and other non-standardized inputs. These inputs may be pre-processed using natural language processing (NLP) techniques, data parsing algorithms, or format-specific extractors to identify components and relationships. The system may then transform the processed data into a graph format, where nodes represent components of the requirements (e.g., logic conditions, thresholds, or actions) and edges capture relationships (e.g., dependencies or triggers). The graph may then be processed using GCNNs. Key features may then be extracted from the graph using methods such as random walk algorithms, semi-supervised learning, and decision tree algorithms. These features are processed through hidden layers in the GCNN, with Rectified Linear Unit (ReLU) activation filtering irrelevant data and SoftMax layers selecting actionable features probabilistically. The actionable nodes and edges may then be passed through a transformer model with multi-head attention mechanisms, which generates modular execution blocks. Each execution block may encapsulate implementation logic, conditions, and relationships derived from the graph. The final output may be a collection of execution blocks formatted as a platform-agnostic API, enabling seamless integration with diverse business systems while eliminating the need for manual formatting or specialized conversion tools.

Embodiments of the disclosure provide a technical solution to the challenges of transforming unstructured requirements into actionable, structured outputs by implementing a novel combination of machine learning techniques and data representations. The overall innovation pipeline integrates GCNNs, probabilistic layers, transformers, and generative AI subsystems to reduce computational overhead and eliminate manual intervention, achieving efficient and scalable generation of implementation protocols. The generative AI subsystem analyzes each implementation protocol to identify functional elements, generates execution blocks encapsulating the implementation logic, and formats these blocks as modular units. An aggregation and presentation subsystem then aggregates the execution blocks into a unified collection and transmits them to the user as a platform-agnostic API. By automating the transformation of unstructured data into structured APIs, the embodiments of the disclosure minimize errors caused by manual formatting, accelerates configuration updates, and optimizes computational resources. Additionally, embodiments of the disclosure improve adaptability by managing rule selections and deselections in response to evolving business needs, enabling faster deployment and real-time updates across various platforms.

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, a “requirement” may refer to a set of rules or conditions generated based on a defined operational context, such as a specific workflow, technical scenario, or business case. The requirement may enable the representation of complex decision-making criteria, facilitating the automation of processes or enforcement of policies across computing environments. The requirement may be derived from one or more predefined parameters, constraints, or objectives and may adapt dynamically to changes in input data or contextual conditions. For example, the requirement may govern data processing workflows, dictate access control policies, or define routing protocols for network traffic; the requirement may also include mechanisms for rule definition, execution, and management, allowing rules to be updated, validated, or optimized without modifying underlying software architectures.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

### Example System Environment

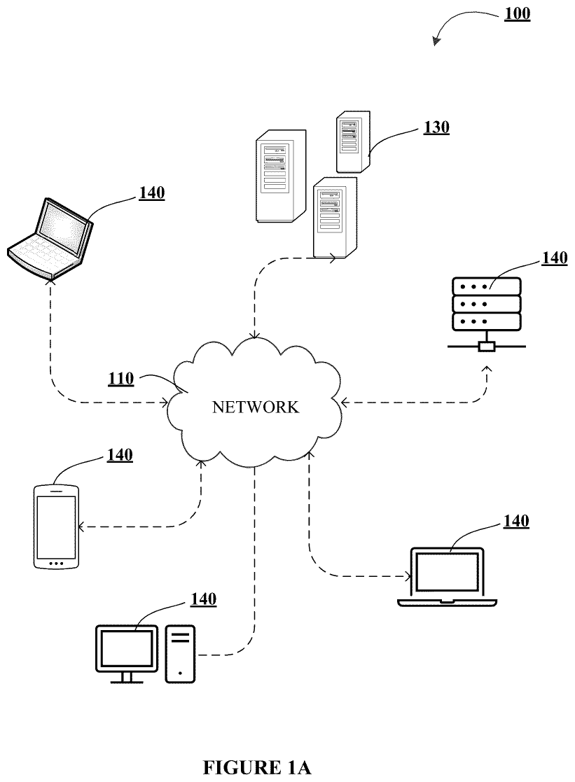

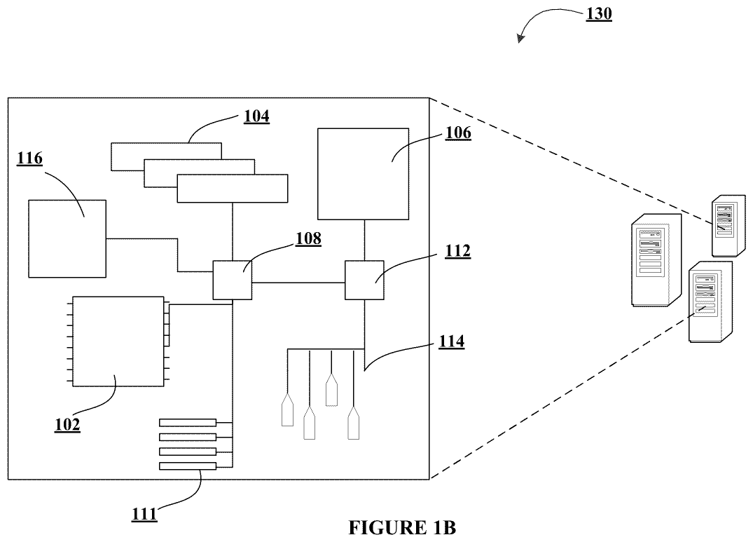

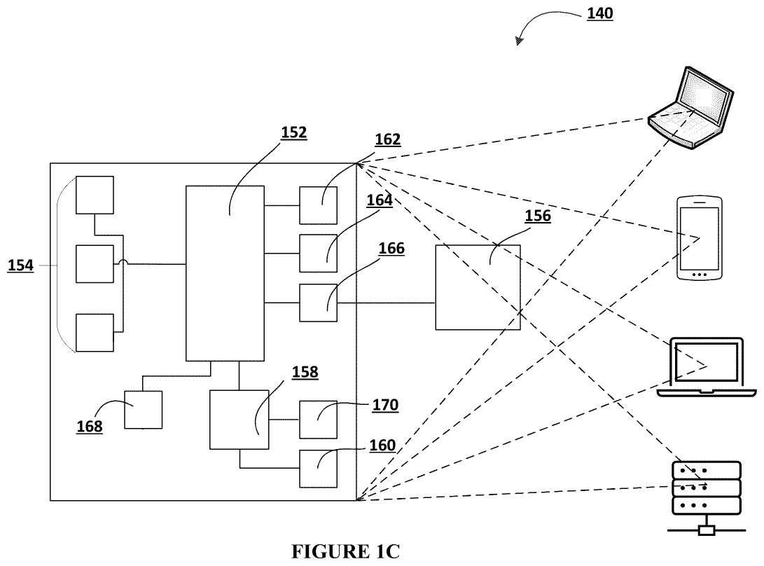

FIGS. 1A-1C illustrate technical components of an exemplary distributed computing environment for generating dynamic implementation protocols 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a plurality of subsystems, such as an input processing subsystem, a machine learning subsystem, a generative AI subsystem, and an aggregation and presentation subsystem, each of which may be configured to execute specialized processes within a larger system (e.g., system 130).

The input processing subsystem may serve as the initial interface for receiving and structuring requirements provided by the user. The input processing subsystem may receive a plurality of requirements, which may be presented in either structured or unstructured formats. For unstructured requirements, the input processing subsystem may preprocess the data using techniques such as NLP, data parsing algorithms, or format-specific extractors. These methods may extract relevant components and identify relationships between the components. Subsequently, the input processing subsystem may represent the extracted components and their relationships as a graph. The graph may comprise a plurality of nodes, where each node represents a component of the requirements, and a plurality of edges, where each edge represents a relationship between these components.

The machine learning subsystem may be configured to process the graph representation provided by the input processing subsystem using GCNN. The machine learning subsystem may analyze the graph to capture both local and global patterns by iteratively aggregating information from the plurality of nodes and edges. In doing so, the machine learning subsystem may identify significant relationships and structures within the requirements graph. The machine learning subsystem may be configured to extract a plurality of features from the nodes and edges by leveraging the GCNN's computational capabilities. These features may include structural, relational, or contextual attributes. Furthermore, the machine learning subsystem may identify actionable nodes and edges within the graph, which may represent specific components or relationships. These components and relationships may be used to generate implementation protocols for each requirement based on the actionable nodes and edges.

The generative AI subsystem may analyze the implementation protocols produced by the machine learning subsystem generate execution blocks for each identified functional element. The generative AI subsystem may involve decomposing each implementation protocol into functional elements and their corresponding execution logic. The analysis may include identifying the implementation logic, conditions, and relationships derived from the actionable nodes and edges processed by the machine learning subsystem. For each functional element, the generative AI subsystem may generate an execution block that encapsulates the required implementation logic in a modular format. Each block may include conditions for execution and interdependencies among the components. The generative AI subsystem may further format these execution blocks as modular units configured for direct integration into various logic frameworks.

The aggregation and presentation subsystem may be configured to aggregate the execution blocks generated by the generative AI subsystem into a unified collection of logic operation modules. The aggregation and presentation subsystem may aggregate individual execution blocks into a cohesive framework, ensuring logical consistency and operational compatibility among the modules. Once aggregated, the aggregation and presentation subsystem may format and transmit the resulting collection of logic operation modules to the user via an application programming interface (API). The API may provide a standardized method for accessing and integrating the aggregated modules into the user's preferred systems or workflows.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

### Example Data Processing Architecture

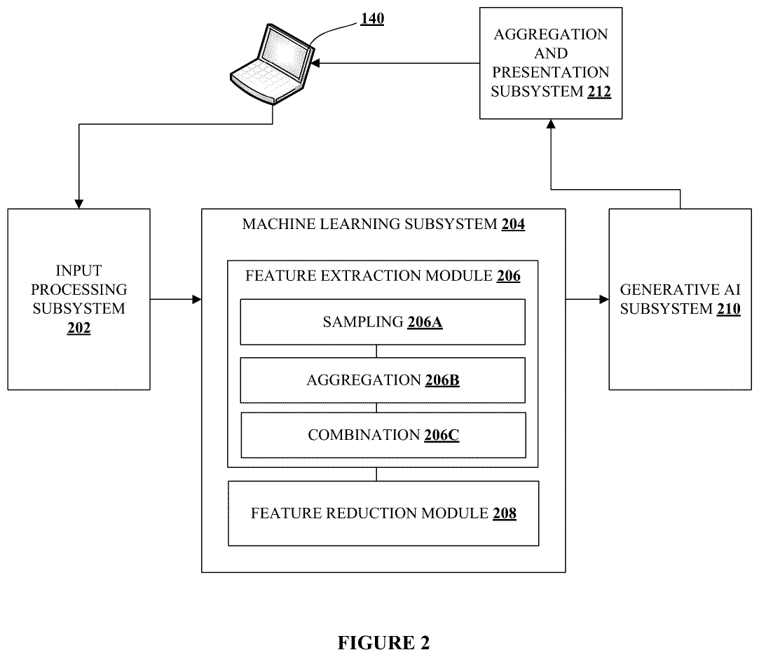

FIG. 2 illustrates an exemplary data processing architecture 200, in accordance with an embodiment of the disclosure. The data processing architecture may include an input processing subsystem 202, a machine learning subsystem 204, a generative AI subsystem 210, and an aggregation and presentation subsystem 212.

The data processing architecture may initiate with an endpoint device 140, which may be a computer, tablet, smartphone, or any other user-operable interface, as described in FIGS. 1A-1C. The endpoint device 140 may be configured to serve as the primary interface for users to input a plurality of requirements into the system. These requirements may be provided in various formats, including structured data (e.g., tabular data or predefined schemas), semi-structured data (e.g., JSON or XML), or unstructured data (e.g., free-form text or uploaded documents).

The input processing subsystem 202 may be configured to receive the requirements transmitted from the endpoint device 140. The input processing subsystem 202 may serve as the intermediary between the user's input and the downstream processing components, such that the requirements are appropriately structured and prepared for further analysis. The input processing subsystem 202 may be configured to perform a series of operations to handle the diverse formats of user-provided requirements. For structured data, the input processing subsystem 202 may directly parse the input using format-specific parsers to extract components and relationships. For semi-structured data, such as JSON or XML, the input processing subsystem 202 may employ schema interpretation algorithms to identify hierarchical structures and derive actionable components. In the case of unstructured data, such as free-form text, the input processing subsystem 202 may preprocess the input using NLP techniques, including tokenization, entity extraction, and relationship identification. Additionally, the input processing subsystem 202 may utilize tools such as optical character recognition (OCR) for digitizing handwritten or scanned documents, or speech-to-text systems for processing audio inputs.

Once the requirements have been processed, the input processing subsystem 202 may structure the data as a graph comprising a plurality of nodes and edges. Each node in the graph represents a component of the requirements (e.g., “authentication module,” “data storage system”), while each edge represents a relationship between these components (e.g., “relies on,” “communicates with”). For instance, a node representing “User Authentication” may connect to a node representing “Data Storage” with an edge labeled “requires encrypted storage; a node representing “Dashboard” may connect to a node representing “Real-Time Data” with an edge labeled “visualizes data.” The graph may then be transmitted to the machine learning subsystem 204 for further processing. In specific embodiments, the input processing subsystem 202 may convert all incoming requirements, regardless of their original format, into a unified structure suitable for machine learning analysis.

The machine learning subsystem 204 may be configured to receive the graph representation of the requirements from the input processing subsystem 202. In response, the machine learning subsystem 204 may implement advanced computational models to analyze the graph, identify patterns, and generate actionable insights necessary for downstream processes. In an example embodiment, the machine learning subsystem may implement GCNN to extract meaningful features from the graph representation of the requirements. To this end, the machine learning subsystem 204 may include at least a feature extraction module 206 and a feature reduction module 208.

The feature extraction module 206 may be configured to extract relevant features from the graph by performing operations corresponding to specific layers of the GCNN. The module may include subcomponents for sampling 206A, aggregation 206B, and combination 206C, which align with the GCNN's input, convolutional, and pooling layers, respectively. For instance, corresponding to the input layer of the GCNN, the sampling 206A may include identifying and selecting a subset of nodes and edges from the graph for processing; corresponding to the GCNN's convolutional layers, the aggregation 206B may include iteratively combining information from neighboring nodes and edges, enabling each node to update its feature vector based on its local neighborhood; and corresponding to the pooling layers of the GCNN, the combination 206C may include integrating features from multiple levels of the graph, merging local patterns with global relationships.

In specific embodiments, sampling 206A may involve identifying and selecting a subset of nodes and edges from the graph representation of the requirements for further processing. The graph, constructed from user-provided requirements, may include nodes representing components (e.g., “Authentication Module,” “Data Storage”) and edges representing relationships between these components (e.g., “depends on,” “communicates with”). The sampling subcomponent 206A reduces the complexity of the graph by focusing on the most relevant regions while preserving its structural integrity.

The sampling process may employ algorithms such as random walk sampling, semi-supervised learning-based selection, and/or the like. Random walk sampling involves traversing the graph by randomly selecting a series of connected nodes, which ensures coverage of critical substructures. For example, a random walk starting from a node representing “Authentication” may traverse to connected nodes such as “Encryption,” “Token Expiration,” and “Key Management,” highlighting dependencies relevant to secure authentication protocols. Random walk may be particularly useful for exploring highly connected regions of the graph. Semi-supervised learning-based selection may use partially labeled data to guide the sampling process. For instance, if a subset of nodes (e.g., “User Authentication” and “Real-Time Data”) is pre-labeled as actionable, the algorithm may prioritize sampling their neighboring nodes and edges to capture additional context. This method may be used to leverage limited labeled data to improve sampling efficiency. By focusing on relevant regions of the graph, the sampling process reduces computational overhead and prepares the graph for the subsequent aggregation phase.

Aggregation 206B may involve iteratively combining information from neighboring nodes and edges to update the feature vector of each node. In the context of the requirements graph, this step enables each node to incorporate contextual information about its dependencies and relationships. The aggregation process may be implemented using summation, averaging, or weighted combinations. For instance, aggregation by summation involves summing the feature vectors of a node's neighbors. For example, if the node representing “User Authentication” is connected to nodes representing “Encryption” and “Token Expiration,” the feature vectors of these neighbors are summed to update the “User Authentication” node's feature vector. This technique captures the cumulative influence of neighboring nodes. Averaging may involve computing the mean of the feature vectors of a node's neighbors. This approach normalizes the contributions of neighbors, ensuring that no single node dominates the aggregated features. For example, the node “Dashboard” connected to nodes “Real-Time Data” and “User Metrics” may compute the average of its neighbors'features to represent its relationships. Weighted aggregation assigns different weights to neighbors based on criteria such as edge strength or node importance. For instance, if the edge between “Authentication” and “Encryption” has a higher weight than the edge between “Authentication” and “Token Expiration,” the “Encryption” node's features will have a greater influence during aggregation. This approach is useful for capturing the relative importance of relationships in the graph. By combining information from neighboring nodes and edges, the aggregation phase enables the GCNN to learn local dependencies and prepare the graph for global-level analysis in the combination phase.

Combination 206C may integrate features across multiple levels of the graph. Combination 206C may merge local patterns captured during aggregation with global relationships to produce a comprehensive representation of the graph's structure and attributes. The combination process may involve hierarchical pooling, attention mechanisms, or graph clustering. Hierarchical pooling may be used to group nodes into clusters based on their structural similarity or connectivity, reducing the graph's size while retaining its essential features. For example, nodes representing “Authentication,” “Encryption,” and “Key Management” may be combined into a single cluster representing the “Security” module. Attention-based combination assigns varying importance to different nodes and edges, allowing the system to prioritize critical relationships. For instance, the relationship between “Real-Time Data” and “Dashboard” may be assigned higher importance than the relationship between “Dashboard” and “Archived Data,” as the former is more relevant to real-time operations. Nodes and edges may then be grouped into clusters based on shared attributes or common patterns. For example, nodes representing user-facing modules (“User Authentication,” “Dashboard”) may form one cluster, while backend modules (“Data Storage,” “Real-Time Data Processing”) may form another. The combination process provides a global understanding of the graph, enabling the system to identify high-level dependencies and relationships for generating implementation protocols. For example, the system may determine that “Dashboard” relies on “Real-Time Data,” which, in turn, depends on “Data Storage,” forming a global dependency chain.

The feature reduction module 208 may be configured to refine the feature set generated during the feature extraction process, such that only the most relevant and actionable features are retained for downstream tasks. Feature reduction may correspond to the output layer of the GCNN and incorporates operations such as rectified linear unit (ReLU) activation and softmax algorithms, which help identify specific nodes and edges while reducing the dimensionality of the processed graph. To this end, the ReLU layer may apply the rectified linear unit activation function to the feature vectors of the graph's nodes. This operation introduces non-linearity into the model, enabling it to focus on positive feature values while discarding irrelevant or less significant information. Specifically, the ReLU function sets all negative feature values to zero, retaining only the positive contributions from each feature. ReLU simplifies the feature space by eliminating noise or irrelevant signals that may arise from earlier stages of feature extraction. For example, in the graph representation of requirements, if a node representing “Archived Data” contributes negligible features to downstream tasks, the ReLU layer effectively nullifies its influence. During feature reduction, the ReLU layer processes each node's feature vector component-wise. For instance, if the feature vector for the “User Authentication” node is [0.3, −0.5, 1.2, −0.1], the ReLU operation converts it to [0.3, 0, 1.2, 0], retaining only the positive contributions. By emphasizing the most critical features, the ReLU layer ensures that the remaining feature set is optimized for identifying actionable nodes and edges.

The softmax algorithm may be used to normalize the refined feature set and prioritize actionable nodes and edges within the graph. Softmax transforms the feature values into probabilities, such that the most relevant components are assigned higher importance. Softmax highlights nodes and edges that are most likely to be actionable based on their refined feature values. For example, nodes with high relevance, such as “Authentication Module” or “Real-Time Data Processing,” are assigned higher probabilities, while less significant nodes, such as “Archived Data,” receive lower probabilities. For each node or edge, the softmax algorithm computes a probability value based on the exponential of its feature vector components. The algorithm normalizes these probabilities so that their sum equals one. For instance, if three nodes have feature scores of [2.0, 1.0, 0.5], the softmax transformation assigns probabilities [0.65, 0.24, 0.11], prioritizing the first node. By converting feature scores into probabilities, the softmax algorithm provides a clear ranking of actionable nodes and edges, facilitating their selection for implementation protocol generation.

The combination of ReLU and softmax operations within the feature reduction module 208 ensures that the system focuses on actionable insights while discarding irrelevant or redundant features. ReLU eliminates non-contributory features by zeroing out negative values, and softmax assigns importance rankings to the remaining features, such that the system may identify nodes and edges specific to the implementation of requirements. For example, in the graph representation of requirements. “User Authentication” node may retain significant positive contributions (e.g., [0.7, 1.2]) after ReLU processing. Softmax may assign the “User Authentication” node a higher priority (e.g., 0.6 probability) compared to less significant nodes like “Archived Data” (e.g., 0.1 probability). As a result, the system focuses on actionable elements such as “Authentication requires Encryption” and “Dashboard visualizes Real-Time Data,” enabling efficient generation of implementation protocols. This refined feature set, optimized through the ReLU layer and softmax algorithm, is then transmitted to the generative AI subsystem 210.

The generative AI subsystem 210 may be configured to generate modular execution blocks based on the refined feature set produced by the machine learning subsystem. In this regard, the generative AI subsystem 210 may leverage transformer-based models to process actionable nodes and edges from the graph, identifying functional elements and their corresponding execution logic. Execution blocks generated by the generative AI subsystem 210 may include implementation logic, conditions, and relationships.

The generative AI subsystem 210 may analyze the actionable nodes and edges in the graph to identify functional elements. Each functional element may represent a discrete task or operation derived from the requirements. In one example, a ode labeled “Authentication” may correspond to the functional element “User Authentication Module,” with connected edges defining constraints such as “requires multi-factor authentication.” In another example, a node labeled “Dashboard” may correspond to the functional element “Visualization Module,” with dependencies on nodes such as “Real-Time Data.”

Once functional elements and their execution logic are identified, the generative AI subsystem 210 may generate execution blocks. Each execution block may include implementation logic, conditions, and relationships. Implementation logic may refer to specific logic required to execute the functional element (e.g., OAuth2 protocol for authentication), conditions may refer to preconditions or constraints for execution (e.g., valid credentials, active session), and relationships may refer to dependencies on other functional elements (e.g., “Visualization Module” depends on “Real-Time Data Processing”).

In specific embodiments, the generative AI subsystem 210 may achieve these tasks through the application of transformer-based models, which are well-suited for analyzing structured and semi-structured data. In particular, the generative AI subsystem 210 may use a transformer-based model to process the graph data (actionable nodes and edges) by encoding it into a latent space. In specific embodiments, encoding may involve self-attention and positional encoding. The self-attention mechanism may evaluate the importance of each node and edge relative to others in the graph. For instance, in generating an execution block for “Authentication,” self-attention may assign higher weights to edges connected to “Encryption” and “Token Expiration,” as these represent dependencies. The attention scores are computed using scaled dot-product operations, which quantify the relevance of each component in the graph. Since transformers are inherently sequence-agnostic, positional encoding captures the structural relationships between nodes and edges. For graph data, this encoding may include topological information, such as node-to-node distances or edge strengths.

Multi-head attention allows the model to analyze multiple aspects of the graph data in parallel. For example, one attention head may focus on functional dependencies, such as “Authentication requires Encryption,” while another attention head may analyze constraints, such as “Token expiration≤1 hour.” Such parallel processing may enable the generative AI subsystem 210 to extract diverse features, improving the quality of execution block generation.

The transformer's decoder component uses the encoded representation to generate execution blocks by predicting their components (e.g., module name, logic, conditions) as a sequence of tokens. Each token is generated iteratively, based on the context provided by previously generated tokens and the attention weights derived during encoding. For instance, the sequence for an “Authentication” block may look like: {“module”: “Authentication”, “method”: “OAuth2”, “conditions”: [ . . . ]}. To improve output quality, the generative AI subsystem 210 may employ beam search, generating multiple candidate blocks and selecting the most likely one.

In specific embodiments, once the relationships between nodes and edges are encoded and processed, the generative AI subsystem 210 may use the representation to generate modular execution blocks tailored to the system's requirements. Each node and its connected edges are mapped to a functional element (e.g., “Visualization Module” or “User Authentication Module”) with associated implementation logic, conditions, and dependencies. Each block is generated in a machine-readable format (e.g., JSON or XML) and may include module name, implementation logic, conditions, and relationships. Execution blocks are configured to be platform-agnostic, enabling seamless integration into diverse deployment environments and ensuring flexibility for system architects.

The aggregation and presentation subsystem 212 may be configured to aggregate the modular execution blocks generated by the generative AI subsystem 210 and present them to the user or downstream systems in a unified format. The aggregation and presentation subsystem 212 may ensure that the outputs are both logically consistent and suitable for integration into external frameworks or workflows. The aggregation process involves combining individual execution blocks into a cohesive collection of logic operation modules. This may include resolving dependencies between blocks, ensuring consistency across conditions and relationships, and optimizing the overall structure of the collection. For example, if the execution block for “Authentication” specifies a dependency on “Encryption Protocol,” the aggregation and presentation subsystem 212 may ensure that the corresponding block for “Encryption Protocol” is included and properly linked. Similarly, the aggregation and presentation subsystem 212 may organize execution blocks hierarchically, grouping related modules together (e.g., all security-related modules such as “Authentication,” “Encryption,” and “Key Management”). The aggregation and presentation subsystem 212 may also perform validation checks to ensure that the aggregated execution blocks satisfy the original requirements and are free from logical conflicts. For instance, it may verify that conditions specified in one block do not contradict those in a dependent block.

Once aggregation is complete, the aggregation and presentation subsystem 212 may format the execution blocks for presentation to the user or for integration into external systems. The aggregated blocks may be transmitted via an application programming interface (API) or other communication methods, such as file-based formats or real-time message streams. The aggregation and presentation subsystem 212 may format the execution blocks as platform-agnostic modules, allowing them to be integrated into various deployment environments. Examples of such formats include JSON, XML, and other domain-specific formats as requested by the user. In certain embodiments, the aggregation and presentation subsystem 212 may include an interactive user interface or dashboard, allowing users to review, edit, and approve the aggregated execution blocks before deployment. This interface may display the execution blocks in a structured manner, showing their relationships, conditions, and dependencies, and may allow for manual adjustments as needed.

It should be understood that the embodiments described herein represent only one example of how the data processing architecture, including the input processing subsystem 202, the machine learning subsystem 204, the generative AI subsystem 210, and the aggregation and presentation subsystem 212, may operate. The specific techniques, models, and algorithms described are provided for illustrative purposes and are not intended to limit the scope of the disclosure. Alternative configurations, methodologies, and technologies may be used to achieve similar functionality across the described subsystems. For instance, while the input processing subsystem 202 is described as using techniques such as NLP, schema interpretation, and optical character recognition (OCR) to preprocess user requirements, other techniques such as probabilistic models, heuristic-based parsing, or specialized data extraction tools may also be employed. Similarly, the machine learning subsystem 204 is described as utilizing GCNN for feature extraction and reduction; however, other machine learning models, such as recurrent neural networks (RNNs), transformers, or support vector machines (SVMs), may be used depending on the specific system design and requirements. Additionally, while the generative AI subsystem 210 is described as leveraging transformer-based models with components such as self-attention and multi-head attention to generate execution blocks, other generative or rule-based techniques, such as variational autoencoders (VAEs), generative adversarial networks (GANs), or expert systems, may be used to perform similar tasks. Similarly, the aggregation and presentation subsystem 212, while described as transmitting execution blocks to the user via an API, may utilize other communication methods, such as message queues, distributed ledger systems, or file-based transfer protocols, to provide the outputs.

The specific choice of models, algorithms, and techniques may vary depending on the requirements of the system, the computational resources available, and the nature of the data being processed. The disclosure is not limited to the precise configurations and methods described herein and may encompass a wide variety of implementations that achieve the same or equivalent outcomes. The descriptions provided herein are intended to be illustrative and exemplary and should not be interpreted as limiting the scope of the disclosure.

### Example Method for Generating Dynamic Implementation Protocol

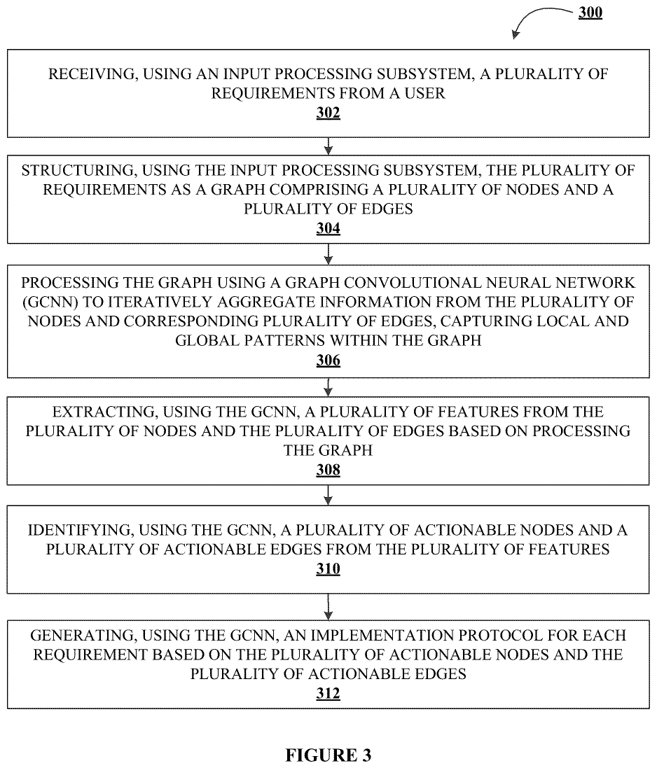

FIG. 3 illustrates a process flow 300 for generating dynamic implementation protocol, in accordance with an embodiment of the disclosure. As shown in block 302, the process flow includes receiving, using an input processing subsystem, a plurality of requirements from a user. The input processing subsystem may receive information from the user in the form of “requirements,” which, as described herein, may represent the specifications, constraints, or goals that the user seeks to implement. These requirements may vary in their structure, complexity, and mode of delivery. The input processing subsystem may handle input in structured formats, such as tabular data, JSON files, or XML schemas, as well as unstructured formats, such as free-form text, handwritten notes (converted via optical character recognition), or spoken instructions (processed using speech-to-text technologies.

In one embodiment, the input requirements may be structured, such as a table detailing system components, their attributes, and interdependencies. For example, a structured table might list system modules, their functionalities, and associated constraints. In another embodiment, the input may consist of unstructured text, such as a paragraph describing the goals of a project and the constraints on its implementation. An example might include the statement: “Develop a web application with a responsive user interface, real-time database updates, and multi-factor authentication.” In yet another embodiment, the requirements may be semi-structured, such as a JSON file with partially defined attributes like module: authentication, method: “”, and constraint: secure.

The input processing subsystem may employ various pre-processing techniques tailored to the type of input. For unstructured text, NLP methods may extract key components and their relationships. For structured or semi-structured input, data parsing algorithms may directly identify components and attributes.

As shown in block 304, the process flow includes structuring the plurality of requirements as a graph, using the input processing subsystem. Once the requirements are received, the input processing subsystem may analyze the data and transform it into a graph-based representation. This graph representation may include a plurality of nodes and plurality of edges. Each node may represent a component or element of the requirements (e.g., “Authentication Module,” “Data Storage,” or “Dashboard”). Each edge may represent a relationship between the components (e.g., “relies on,” “communicates with,” or “requires”).

Each node in the graph may correspond to a specific component extracted from the requirements. For example, a structured table specifying “modules” and “constraints” may produce nodes for “Authentication Module” and “Token Expiration”; a semi-structured JSON file may define nodes such as “Dashboard” or “Real-Time Data”; and an unstructured text input, such as “The system must have encrypted data storage,” may produce a node labeled “Data Storage.”

The edges in the graph may be derived from relationships between components, which may be explicitly defined or inferred using preprocessing techniques. For instance, a requirement specifying “Authentication relies on Encryption” may result in an edge labeled “relies on” between “Authentication” and “Encryption.” Similarly, an edge labeled “requires” may connect “Dashboard” to “Real-Time Data,” indicating that the dashboard depends on live updates.

The input processing subsystem may employ various algorithms and pre-processing techniques to construct the graph. For instance, for unstructured text, the input processing subsystem may implement NLP methods such as entity recognition and relationship extraction to identify key components and their connections; for semi-structured data, the input processing subsystem may interpret the hierarchy to extract nodes and edges; for structured formats, such as tables, the input processing subsystem may directly map columns to nodes and infer edges based on predefined rules or contextual analysis. In one example, a graph may include, nodes: “Authentication Module,” “Encryption Protocol,” “Dashboard,” “Real-Time Data Processing,” and edges: “Authentication Module”→“Encryption Protocol” (labeled “relies on”), and “Dashboard”→“Real-Time Data Processing” (labeled “requires”).

As shown in block 306, the process flow includes processing the graph using a GCNN to analyze the structured graph representation of the requirements. The GCNN may iteratively process the graph, aggregating information from the nodes and edges to capture both local and global patterns.

As described herein, a GCNN may be a machine learning model configured to process graph-structured data. Unlike conventional neural networks, which process data in vectorized form, GCNNs operate directly on graph representations, enabling the system to analyze the relationships and interactions between components. The GCNN processes the graph through multiple layers, each performing specific operations: (i) input layer—the graph's initial structure, including the feature vectors of nodes and edges, is fed into the model, (ii) convolutional layers-these layers aggregate information from neighboring nodes and edges, updating each node's feature vector based on its local neighborhood, (iii) pooling layers-these layers reduce the graph's complexity by combining features across nodes and edges to capture higher-level patterns, and (iv) output layers-the final output is a set of refined feature vectors representing actionable nodes and edges in the graph.

During operation, the GCNN aggregates information from each node's neighbors to update its feature vector. For example, a node representing “Authentication Module” may aggregate features from its neighbors, such as “Encryption Protocol” and “Token Expiration,” to capture dependencies relevant to secure authentication. The edges between these nodes (e.g., “relies on” or “requires”) are also incorporated to refine the node's representation. Then the GCNN captures both local and global patterns in the graph. Local patterns may refer to relationships between closely connected nodes, such as “Dashboard” requiring “Real-Time Data,” are identified and analyzed, while global patterns may refer to higher-order dependencies, such as how “Real-Time Data Processing” depends on “Data Storage,” are extracted by processing multiple layers of the graph. These actionable components form the basis for downstream tasks, such as feature extraction and implementation protocol generation.

As shown in block 308, the process flow includes extracting, using the GCNN, a plurality of features from the plurality of nodes and the plurality of edges based on processing the graph. The GCNN may process the graph iteratively, extracting features from both the nodes and their corresponding edges to capture the structural and relational aspects of the requirements. As described herein, each node in the graph may represent a component of the requirements, such as “Authentication Module” or “Data Storage.” Node features may include attributes such as type, functionality, constraints, or priority. Each edge may represent a relationship between components, such as “relies on” or “communicates with.” Edge features may include the type of relationship, edge weight, and any associated conditions or constraints.

The GCNN may extract features by aggregating information from each node's local neighborhood, which includes both its direct neighbors (nodes) and the relationships (edges) connecting them. To the end, the GCNN may accomplish this in three stages—sampling, aggregation, and combination—each aligned with specific layers of the GCNN, as described in detail in FIG. 2. During sampling, the GCNN may identify and select relevant nodes and edges for processing. For example, nodes with higher connectivity or edge weights, such as “Authentication Module” and its dependency on “Encryption Protocol,” may be prioritized. During aggregation, the GCNN may combine information from neighboring nodes and edges to compute an updated feature vector for each node. For instance, the feature vector of “Authentication Module” may be updated based on the aggregated features of its neighbors, such as “Encryption Protocol” and “Token Expiration.” During combination, the GCNN may integrate features across multiple levels of the graph to produce a comprehensive representation. This may involve merging local dependencies (e.g., “Dashboard requires Real-Time Data”) with global relationships (e.g., “Real-Time Data depends on Data Storage”).

By extracting features from both nodes and edges, the GCNN captures not only the characteristics of individual components but also the dependencies and interactions between them. This comprehensive feature set provides the foundation for identifying actionable nodes and edges, which are subsequently used to generate implementation protocols.

As shown in block 310, the process flow includes identifying, using the GCNN, a plurality of actionable nodes and a plurality of actionable edges from the plurality of features. The GCNN analyzes the extracted features to determine which nodes and edges in the graph are important for fulfilling the requirements and generating implementation protocols. This step enables the system to isolate the most relevant components and relationships within the graph for downstream tasks. Actionable nodes may refer to nodes that represent critical components of the requirements that are necessary for implementation. For example, a node labeled “Authentication Module” may be identified as actionable because it is central to securing user access. A node labeled “Dashboard” may be actionable due to its dependency on real-time data for visualization purposes. The GCNN may evaluate the features of each node, such as connectivity, functional attributes, and associated constraints, to determine its relevance. Nodes with higher feature weights, stronger dependencies, or direct ties to other critical nodes are more likely to be identified as actionable.

Actionable edges may refer to edges that represent key relationships or dependencies between components. For example, an edge labeled “relies on” between “Authentication Module” and “Encryption Protocol” may be actionable because encryption is a required dependency for authentication. An edge labeled “requires” between “Dashboard” and “Real-Time Data” may be actionable as it indicates a direct dependency for live updates. The GCNN may use edge features, such as relationship type, weight, and associated conditions, to assess the importance of each connection. Relationships that are essential for functional integrity or meeting system constraints are marked as actionable.

In specific embodiments, the GCNN may identify actionable nodes and edges by evaluating their features using techniques such as, (i) feature weighting-nodes and edges with higher feature weights (e.g., importance or dependency scores) are more likely to be actionable, (ii) neighborhood analysis-the GCNN may consider the local neighborhood of each node, assessing how it interacts with and depends on its neighbors, (iii) ReLU-the GCNN map apply ReLU to filter out less significant features, ensuring that only positive contributions are retained during this process, and (iv) softmax prioritization-actionable components may be further prioritized using softmax normalization, assigning higher probabilities to the most critical nodes and edges. The identification of actionable nodes and edges enables the system to focus on the most relevant aspects of the requirements. These actionable components are subsequently used by the GCNN to generate detailed implementation protocols tailored to the user's requirements.

As shown in block 312, the process flow includes generating, using the GCNN, an implementation protocol for each requirement based on the plurality of actionable nodes and the plurality of actionable edges. Each implementation protocol may include functional elements and their corresponding execution logic, derived from the actionable nodes and edges identified in the graph. The functional elements may represent discrete components or tasks extracted from the actionable nodes in the graph. These elements define what is to be implemented to fulfill a specific requirement. For example, a functional element corresponding to the “Authentication Module” may specify “User Authentication using OAuth2.” The execution logic may define how each functional element operates, including its conditions, constraints, and dependencies. This logic may be derived from the actionable edges and the relationships they represent. For instance, for the “Authentication Module,” the execution logic may specify: “Requires Encryption Protocol and enforces token expiration≤1 hour.” Each implementation protocol combines its functional elements with corresponding execution logic to provide a structured, machine-readable output. For example, the authentication protocol may include a functional element: “User Authentication using OAuth2,” and an execution logic: “Requires valid credentials, multi-factor authentication, and Encryption Protocol.”

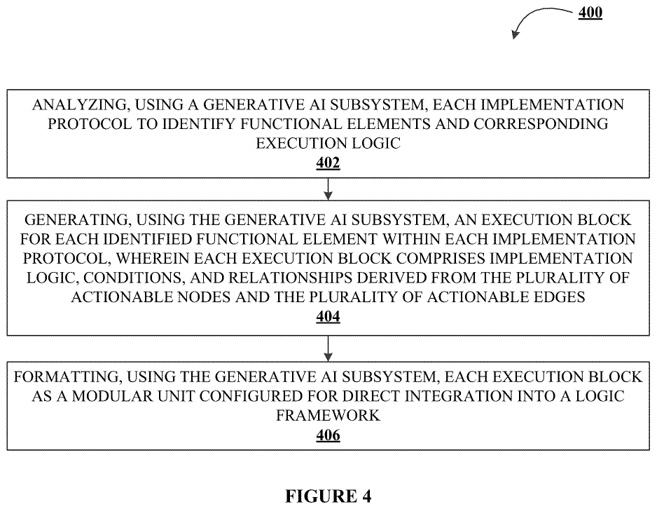

The implementation protocols may then be transmitted to the generative AI subsystem for further processing. The generative AI subsystem uses these protocols as input to generate execution blocks, which are modular and actionable representations of the functional elements and execution logic, as described in further detail in FIG. 4.

### Example Method for Generating Execution Blocks

FIG. 4 illustrates a process flow 400 for generating execution blocks, in accordance with an embodiment of the disclosure. As shown in block 402, the process flow includes analyzing, using a generative AI subsystem, each implementation protocol to identify functional elements and corresponding execution logic. As described in FIG. 2, the generative AI subsystem may employ NLP, rule-based analysis, and transformer-based models to extract and structure the functional elements and execution logic from each implementation protocol.

As shown in block 404, the process flow includes generating, using the generative AI subsystem, an execution block for each identified functional element within each implementation protocol. Each execution block encapsulates the implementation logic, conditions, and relationships derived from the actionable nodes and actionable edges. Each execution block may be generated as a structured, modular unit representing a functional element's logic and dependencies. For instance, the execution block may include implementation logic that specifies the steps required to execute the functional element, conditions that include any preconditions or constraints necessary for execution, and relationships that detail dependencies on other functional elements within the system. As such, each execution block is a self-contained unit of implementation that specifies what needs to be done (functional element) and how it should be executed (execution logic). The execution block translates high-level requirements from the implementation protocol into a structured format that can be processed, automated, or integrated into system workflows. Each execution block may define a implementable, consumable rule method.

As shown in block 406, the process flow includes formatting, using the generative AI subsystem, each execution block as a modular unit configured for direct integration into a logic framework. The resulting execution blocks may be platform-agnostic and can be deployed in various computing environments.

In some embodiments, the system may include an aggregation and presentation subsystem. The aggregation and presentation subsystem may be configured to aggregate execution blocks into a unified collection of logic operation modules and to transmit the aggregated execution blocks to the user via an application programming interface (API). The aggregation and presentation subsystem may ensure that the execution blocks generated by the generative AI subsystem are organized, formatted, and delivered in a structured manner that facilitates their direct use in system implementations. The aggregation process may involve combining execution blocks generated for individual functional elements into a unified collection of logic operation modules. Each execution block, representing a discrete system component (e.g., “User Authentication,” “Data Storage”), may be grouped with related blocks to form a logically consistent framework. In particular embodiments, the aggregation and presentation subsystem may be configured to order and structure the execution blocks based on their dependencies. If an execution block specifies that “Authentication” relies on “Encryption Protocol,” the aggregated module ensures that encryption is processed before authentication logic is applied.

Once execution blocks are aggregated into a unified collection of logic modules, the aggregation and presentation subsystem may be configured to transmit the aggregated execution blocks to the user via an API. The API serves as the interface for users or external systems to retrieve, review, and integrate the execution blocks into various computing environments.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for generating implementation protocols, the system comprising:
an input processing subsystem, wherein the input processing subsystem is configured to:
receive a plurality of requirements from a user; and
structure the plurality of requirements as a graph comprising a plurality of nodes and a plurality of edges, wherein the plurality of nodes represents components of the plurality of requirements and the plurality of edges represents relationships between the components; and
a machine learning subsystem configured operatively coupled to the input processing subsystem, wherein the machine learning subsystem is configured to:
process the graph using a Graph Convolutional Neural Network (GCNN) to iteratively aggregate information from the plurality of nodes and corresponding plurality of edges, capturing local and global patterns within the graph;
extract, using the GCNN, a plurality of features from the plurality of nodes and the plurality of edges based on processing the graph;
identify, using the GCNN, a plurality of actionable nodes and a plurality of actionable edges from the plurality of features; and
generate, using the GCNN, an implementation protocol for each requirement based on the plurality of actionable nodes and the plurality of actionable edges.

2. The system of claim 1, further comprising a generative AI subsystem operatively coupled to the machine learning subsystem, wherein the generative AI subsystem is configured to:
analyze each implementation protocol to identify functional elements and corresponding execution logic;
generate an execution block for each identified functional element within each implementation protocol, wherein each execution block comprises implementation logic, conditions, and relationships derived from the plurality of actionable nodes and the plurality of actionable edges; and
format each execution block as a modular unit configured for direct integration into a logic framework.

3. The system of claim 2, further comprising an aggregation and presentation subsystem operatively coupled to the generative AI subsystem, wherein aggregation and presentation subsystem is further configured to:
aggregate the execution blocks into a unified collection of logic operation modules; and
transmit the aggregated execution blocks to the user via an application programming interface (API).

4. The system of claim 2, wherein the execution blocks are platform agnostic.

5. The system of claim 1, wherein the plurality of requirements is in an unstructured format, and wherein the input processing subsystem is configured to:
pre-process the unstructured data using at least one of natural language processing (NLP) techniques, data parsing algorithms, or format-specific extractors to extract components and relationships between the components for graph construction.

6. The system of claim 1, wherein extracting the plurality of features and the plurality of edges further comprises using random walk algorithms, semi-supervised learning algorithms, and/or decision tree algorithms.

7. The system of claim 1, wherein identifying the plurality of actionable nodes and the plurality of actionable edges further comprises using a rectified linear unit (ReLU).

8. A method for generating implementation protocols, the method comprising:
receiving, using an input processing subsystem, a plurality of requirements from a user;
structuring, using the input processing subsystem, the plurality of requirements as a graph comprising a plurality of nodes and a plurality of edges, wherein the plurality of nodes represents components of the plurality of requirements and the plurality of edges represents relationships between the components;
processing the graph using a Graph Convolutional Neural Network (GCNN) to iteratively aggregate information from the plurality of nodes and corresponding plurality of edges, capturing local and global patterns within the graph;
extracting, using the GCNN, a plurality of features from the plurality of nodes and the plurality of edges based on processing the graph;
identifying, using the GCNN, a plurality of actionable nodes and a plurality of actionable edges from the plurality of features; and
generating, using the GCNN, an implementation protocol for each requirement based on the plurality of actionable nodes and the plurality of actionable edges.

9. The method of claim 8, wherein the method further comprises:
analyzing, using a generative AI subsystem, each implementation protocol to identify functional elements and corresponding execution logic;
generating, using the generative AI subsystem, an execution block for each identified functional element within each implementation protocol, wherein each execution block comprises implementation logic, conditions, and relationships derived from the plurality of actionable nodes and the plurality of actionable edges; and
formatting, using the generative AI subsystem, each execution block as a modular unit configured for direct integration into a logic framework.

10. The method of claim 9, wherein the method further comprises:
aggregating, using an aggregation and presentation subsystem, the execution blocks into a unified collection of logic operation modules; and
transmitting, using the aggregation and presentation subsystem, the aggregated execution blocks to the user via an application programming interface (API).

11. The method of claim 9, wherein the execution blocks are platform agnostic.

12. The method of claim 8, wherein the plurality of requirements is in an unstructured format, and wherein the method further comprises:
pre-process, using the input processing subsystem, the unstructured data using at least one of natural language processing (NLP) techniques, data parsing algorithms, or format-specific extractors to extract components and relationships between the components for graph construction.

13. The method of claim 8, wherein extracting the plurality of features and the plurality of edges further comprises using random walk algorithms, semi-supervised learning algorithms, and/or decision tree algorithms.

14. The method of claim 8, wherein identifying the plurality of actionable nodes and the plurality of actionable edges further comprises using a rectified linear unit (ReLU).

15. A computer program product for generating implementation protocols, the computer program product comprising a non-transitory computer-readable medium comprising code configured to cause an apparatus to:
receive, using an input processing subsystem, a plurality of requirements from a user;
structure, using the input processing subsystem, the plurality of requirements as a graph comprising a plurality of nodes and a plurality of edges, wherein the plurality of nodes represents components of the plurality of requirements and the plurality of edges represents relationships between the components;
processing the graph using a Graph Convolutional Neural Network (GCNN) to iteratively aggregate information from the plurality of nodes and corresponding plurality of edges, capturing local and global patterns within the graph;
extracting, using the GCNN, a plurality of features from the plurality of nodes and the plurality of edges based on processing the graph;
identifying, using the GCNN, a plurality of actionable nodes and a plurality of actionable edges from the plurality of features; and
generating, using the GCNN, an implementation protocol for each requirement based on the plurality of actionable nodes and the plurality of actionable edges.

16. The computer program product of claim 15, wherein the code further causes the apparatus to:
analyze, using a generative AI subsystem, each implementation protocol to identify functional elements and corresponding execution logic;
generate, using the generative AI subsystem, an execution block for each identified functional element within each implementation protocol, wherein each execution block comprises implementation logic, conditions, and relationships derived from the plurality of actionable nodes and the plurality of actionable edges; and
format, using the generative AI subsystem, each execution block as a modular unit configured for direct integration into a logic framework.

17. The computer program product of claim 16, wherein the code further causes the apparatus to:
aggregate, using an aggregation and presentation subsystem, the execution blocks into a unified collection of logic operation modules; and
transmit, using the aggregation and presentation subsystem, the aggregated execution blocks to the user via an application programming interface (API).

18. The computer program product of claim 16, wherein the execution blocks are platform agnostic.

19. The computer program product of claim 15, wherein the plurality of requirements is in an unstructured format, and wherein the code further causes the apparatus to:
pre-process, using the input processing subsystem, the unstructured data using at least one of natural language processing (NLP) techniques, data parsing algorithms, or format-specific extractors to extract components and relationships between the components for graph construction.

20. The computer program product of claim 15, wherein extracting the plurality of features and the plurality of edges further comprises using random walk algorithms, semi-supervised learning algorithms, and/or decision tree algorithms.
